(19) United States
(12) Patent Application Publication
(10) Pub. No.: US 2012/0239784 A1
(43) Pub. Date: Sep. 20, 2012

(54) Communication System and Peer to Peer Transmission Method

(76) Inventor: Chieh-Yi Lin, New Taipei City (TW)

(21) Appl. No.: 13/165,804

(22) Filed: Jun. 22, 2011

(30) Foreign Application Priority Data
Mar. 14, 2011 (TW) 100108498

(51) Int. Cl. G06F 15/16

(52) U.S. Cl. 709/219

(57) ABSTRACT

A communication system capable of performing peer-to-peer transmission is disclosed. The communication system includes a plurality of client groups, a plurality of first switches, coupled to the plurality of client groups, respectively, a second switch, and a plurality of servers, coupled to the plurality of first switches via the second switch, for storing a plurality of files. A first server of the plurality of servers and a first client group of the plurality of client groups transmits a first file stored in the first server in a peer-to-peer manner, to deploy the first file in all clients of the first client group.

### BACKGROUND OF THE INVENTION

1. Field of the Invention

The present invention relates to a communication system and peer-to-peer (P2P)transmission method, and more particularly, to a communication system and related P2P transmission method capable of transmitting in a P2P manner, so as to speed up deployment of a plurality of different system image files in a plurality of client groups.

2. Description of the Prior Art

During production of computers or notebook computers, in every different production phase it is necessary to import different system image files, e.g. for hardware verification or for importing client customized systems, etc. Two common methods for importing system images include server-to-client and multicast.

With the server-to-client method, after the clients directly request the servers for the system image files, the servers directly transmit the image files to the clients, which is the simplest and most straightforward solution. However, since each time the server can only provide a single system image file to a single client, and all clients obtain the system image files from the same server, an overload would occur on the server when there is an increase in a quantity of clients and image file size. Additionally, since all clients and servers share a fixed bandwidth, the deployment time for the image files increases linearly.

On the other hand, with the multicast method, the server forwards the system image files to all clients using multicast. In other words, image file packets sent out by the server do not specify physical MAC (Media Access Control) addresses for specific clients; therefore, when a switch receives such image file packets, the packets are forwarded to all clients. In such a case, optimal efficiency is guaranteed, as long as the server is only required to transmit a single system image file. However, under the circumstances that multiple producers need to import different system image files during different production phases to different client groups, this implies that the servers are required to concurrently transmit more than one system image file. Since all the clients and servers share a fixed bandwidth, the required time for multicast would increase with the quantity of system image file to transmit. For example, assuming that transmitting an image file takes four minutes, then concurrently transmitting eight image files would take 32 minutes, since each of the eight image files can only be transmitted via multicast utilizing one-eighth of the total bandwidth.

Moreover, in multicast transmission, increasing the quantity of servers does not increase multicast performance. This is because that multicast forwards image file packets to all clients, and the performance of the multiple servers concurrently transmitting image files via multicast still depends on network speed, i.e. the shared fixed bandwidth. Additionally, a further disadvantage of multicast is that packets are transmitted over User Datagram Protocol (UDP), and thus it does not guarantee that packets are transmitted to the clients. Supposing a client does not receive a packet, the server has to retransmit another packet, thus affecting network performance.

For both of the two above-mentioned conventional import methods, deployment time for system images increase with the quantity of image files to be imported. Hence, it is necessary to improve over the prior art.

### SUMMARY OF THE INVENTION

Therefore, a primary objective of the present invention is to provide a communication system capable of performing P2P transmission to speed up deployment times of a plurality of different system image files to a plurality of client groups, respectively, and related P2P transmission method.

An embodiment of the invention discloses a communication system, capable of performing P2P transmission, including a plurality of client groups; a plurality of first switches, coupled to the plurality of client groups, respectively; a second switch; and a plurality of servers, coupled to the plurality of first switches via the second switch, for storing a plurality of files; wherein a first server of the plurality of servers and a first client group of the plurality of client groups transmit a first file stored in the first server in a P2P manner, to deploy the first file in all clients of the first client group.

An embodiment of the invention further discloses a P2P transmission method, for a communication system, the communication system including a plurality of client groups respectively coupled to a plurality of first switches, and a plurality of servers coupled to the plurality of first switches via a second switch, for storing a plurality of files. The P2P transmission method includes a first server of the plurality of servers and a first client group of the plurality of client groups transmitting a first file stored in the first server in the P2P manner; and to deploy the first file to all clients of the first client group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an embodiment of the invention.

FIG. 2 is a schematic diagram of the server and the client group shown in FIG. 1 conducting P2P transmission, according to an embodiment of the invention.

FIG. 3 to FIG. 11 are schematic diagrams of operations of a server and a client group shown in FIG. 1 conducting peer-to-peer (P2P) transmission, according to an embodiment of the invention.

FIG. 12 is a schematic diagram of a P2P transmission process, according to an embodiment of the invention.

### DETAILED DESCRIPTION

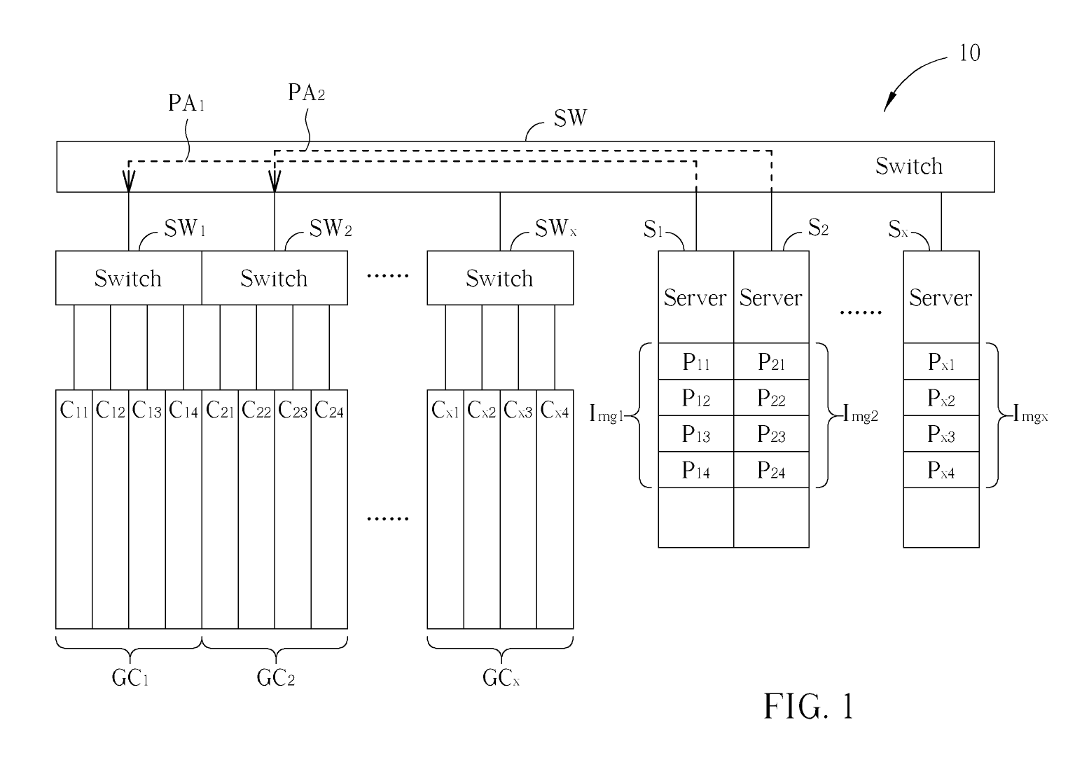

Please refer to FIG. 1, which is a schematic diagram of a communication system 10 according to an embodiment of the invention. As shown in FIG. 1, the communication system 10 includes client groups GC₁-GCₓ, switches SW1-SWₓ, SW and servers S₁-Sₓ. The switches SW1-SWₓ are coupled to the client groups GC₁-GCₓ respectively, and the servers S₁-Sₓ are coupled to the switches SW1-SWₓ via the switch SW, and used for storing files Img₁-Imgₓ respectively. Preferably, the files Img₁-Imgₓ are a plurality of different system image files, but can also be any other kinds of files. Preferably, a client group GCₐ under a given switch SWₐ includes clients that need to be deployed with a same system image file, wherein a quantity of clients in a client group is not limited to 4, but may also be any other quantity. A quantity of the servers S₁-Sₓ preferably equals a quantity of different files Img₁-Imgₓ, each of the servers for storing a file of the different files Img₁-Imgₓ, respectively, but this is not limited thereto.

In short, the server S₁ and the client group GC₁ are able to transmit a file Img₁ stored in the server S₁ in a peer-to-peer (P2P) manner, so as to deploy the file Img₁ to all clients C₁₁-C₁₄ in the client group GC₁. Similarly, the servers S₂-Sₓ and the client groups GC₂-GCₓ may transmit the files Img₂-Imgₓ stored in the servers S₂-Sₓ in the P2P manner, so as to deploy the files Img₂-Imgₓ to all clients in each of the client groups GC₂-GCₓ, respectively. As such, since the servers S₁-Sₓ concurrently transmit the files Img₁-Imgₓ to the client groups GC₁-GCₓ in the P2P manner, they do not share a fixed bandwidth. Therefore, when there is an increase in the quantity of different system image files that need to be deployed, the communication system 10 may increase the quantity of the servers accordingly, so as to speed up the deployment of the system image files in the client groups.

In more detail, since the conventional multicast method does not specify a Media Access Control (MAC) address for each specific client, when such an image file packet is received by a switch, it is forwarded to all of the clients. Comparatively, in an embodiment of the invention, when transmitting in the P2P manner, since each packet specifies a MAC address for each receiving end, the switch SW is able to parallel process each packet to another corresponding port, without affecting other ports (i.e. it is unnecessary to forward the packet to any other unspecified ports). For example, the server S₁ transmits packets to the switch SW₁ (corresponding to the client group GC₁) via the switch SW (i.e. path PA₁), while the server S₂ transmits packets to the switch SW₂ (corresponding to the client group GC₂) via the switch SW (i.e. path PA₂). Therefore, the servers S₁ and S₂ may transmit concurrently without affecting each other's bandwidths. As such, a required time for the servers S₁-Sₓ to concurrently transmit the files Img₁-Imgₓ to the client groups GC₁-GCₓ in the P2P manner, respectively, is the same as a time required for a single server Sₐ to transmit a file Imgₐ to a single client group GCₐ. Therefore, the communication system 10 may increase the quantity of servers accordingly, when there is a demand for deploying more different system image files. As a result, the deploy time can be maintained to be the same as that for deploying a single system image file, and is unlike conventional multicast methods, in which the deploy time increases proportionally with an increase in the quantity of different system image files to be deployed.

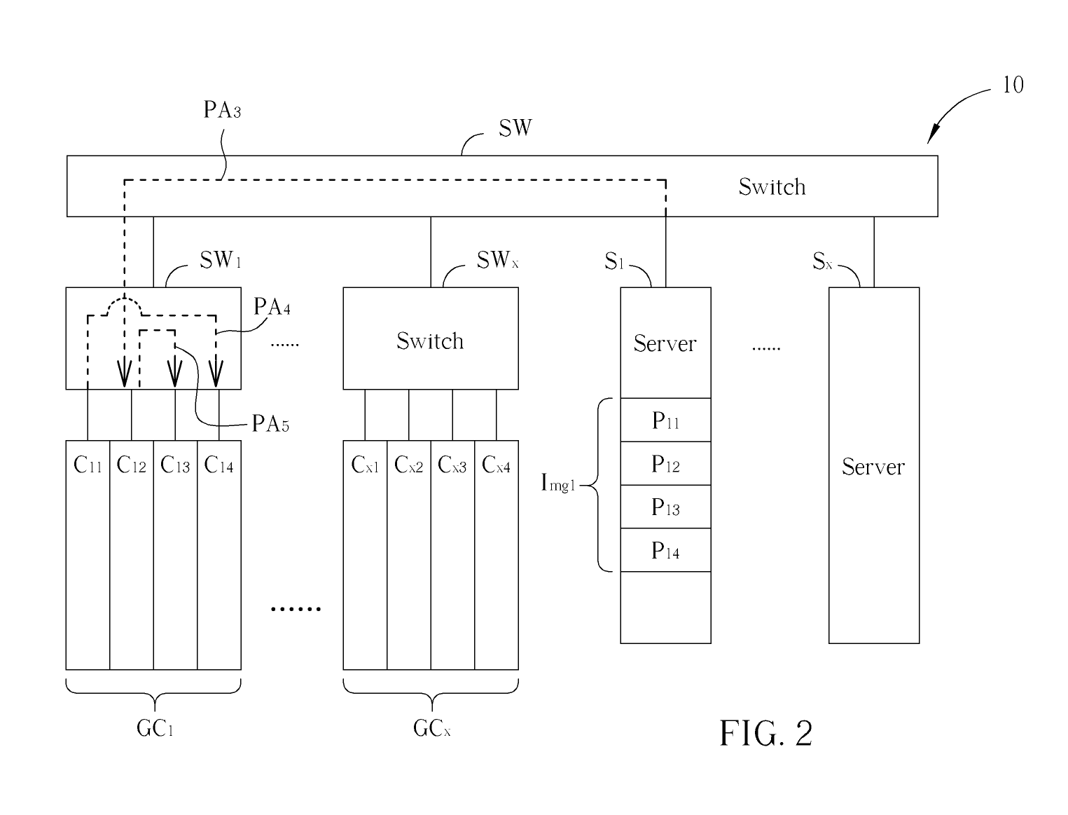

On the other hand, for any given client group GCₐ, the switch SWₐ is also capable of parallel processing and forwarding packets from one port to another port, without affecting any other ports. For example, please refer to FIG. 2, which is a schematic diagram of the server S₁ and the client group GC₁ shown in FIG. 1 performing P2P transmission according to an embodiment of the invention. In FIG. 2, the server S₁ transmits to the clients C₁₂ via the switch SW, followed by the switch SW₁ (i.e. path PA₃), while the client C₁₁ concurrently transmits to the client C₁₄ via the switch SW1 (i.e. path PA₄). Thus, transmissions along the paths PA₃ and PA₄ may take place concurrently, without affecting each other's bandwidths. Furthermore, the client C₁₁ transmits to the clients C₁₄ via the switch SW1 (i.e. path PA₄), while the client C₁₂ transmits to the client C₁₃ via switch SW1 (i.e. path PA₅). Similarly, transmissions along the paths PA₄ and PA₅ may also take place concurrently, without affecting each other's bandwidths.

In such a case, when the server Sₐ transmits the file Imgₐ to the client group GCₐ in the P2P manner, the file Imgₐ is preferably divided into different parts Pₐ₁-Pₐ₄ to perform the P2P transmission (here a quantity of parts equals the quantity of the clients Cₐ₁-Cₐ₄ as an example, but this is not limited thereto), such that the server Sₐ and the clients Cₐ₁-Cₐ₄ in the client group GCₐ may concurrently transmit the parts Pₐ₁-Pₐ₄ using P2P transmission, without affecting each other's bandwidths, thus speeding up transmission for the file Imgₐ. For example, the part Pₐ₁ may be transmitted via P2P in three ways. For example, the server Sₐ first transmits the part Pₐ₁ to a client Cₐ₁ in the P2P manner, and the client Cₐ₁ then transmits the part Pₐ₁ to another client Cₐ₄ via P2P, and finally the client Cₐ₄ transmits the part Pₐ₁ to another client Cₐ₃ other than the client Cₐ₁. Similar processes may be derived for the parts Pₐ₂-Pₐ₄. As such, by suitably arranging the parts Pₐ₁-Pₐ₄ to transmit via P2P transmission in the above-mentioned three ways, each of the parts Pₐ₁-Pₐ₄ may be transmitted via different paths, without affecting each others' bandwidths, thus speeding up transmission for the file Imgₐ.

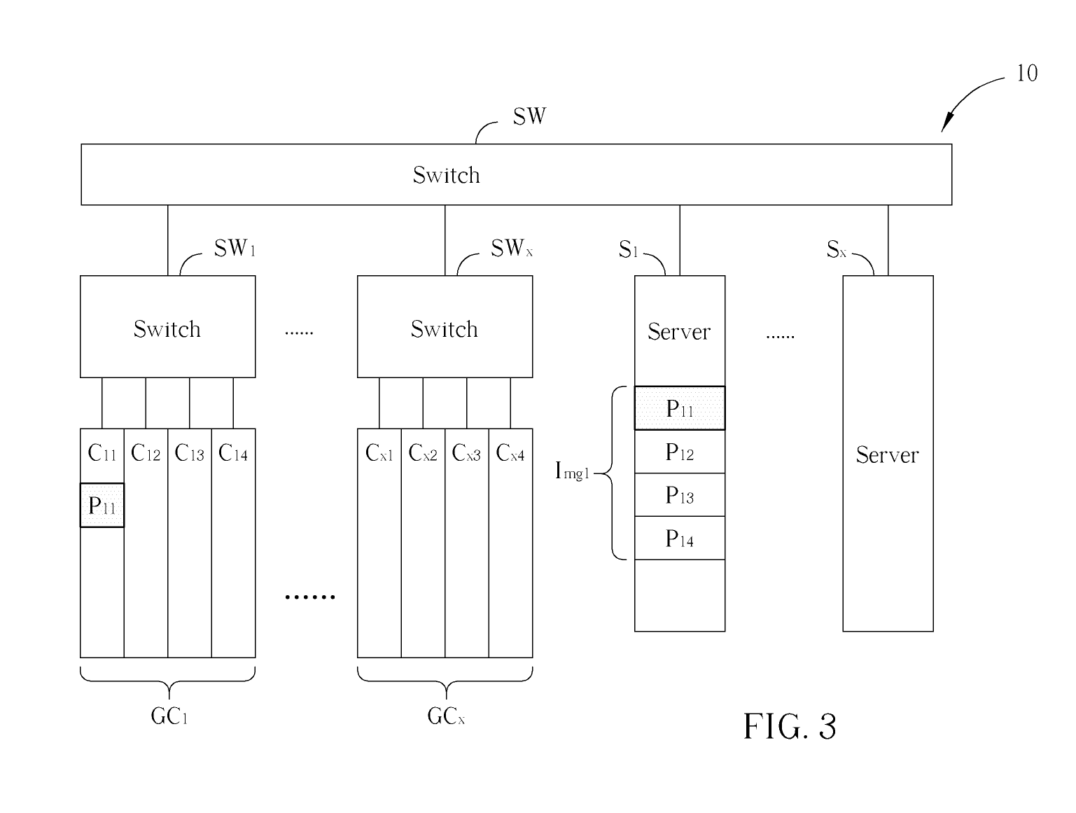

For example, please refer to FIGS. 3 to 11, which are schematic diagrams of operations of the server S₁ and the client groups GC₁ shown in FIG. 1 conducting P2P transmission according to an embodiment of the invention, wherein a halftone filled region indicates the part being transmitted presently:

as shown in FIG. 3, the server S₁ transmits the part P₁₁ to the client C₁₁.

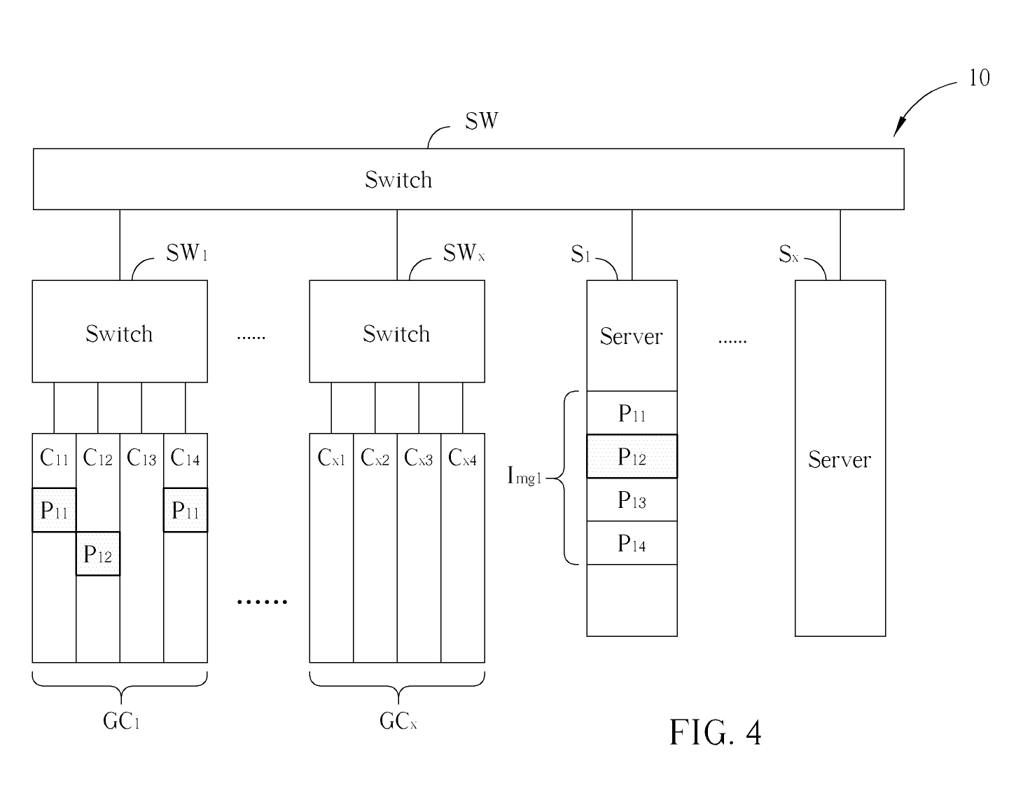

as shown in FIG. 4, the server S₁ transmits the part P₁₂ to the client C₁₂, and the client C₁₁ transmits the part P₁₁ to the client C₁₄.

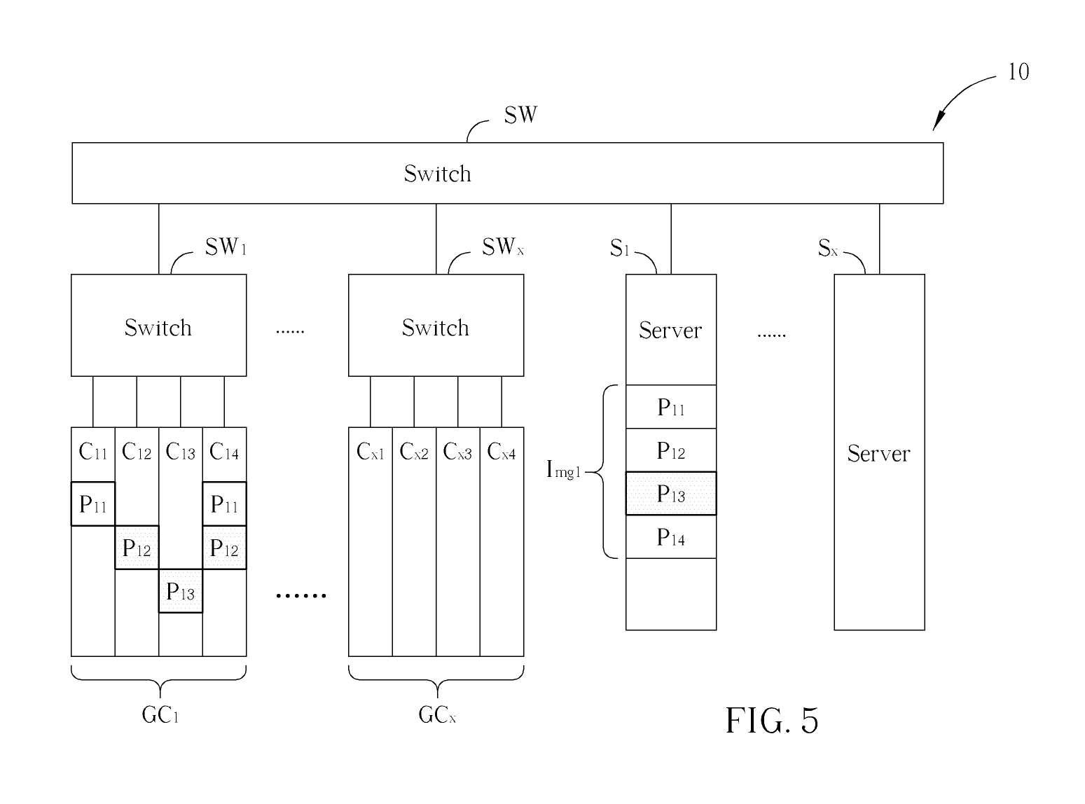

as shown in FIG. 5, the server S₁ transmits the part P₁₃ to the client C₁₃, and the client C₁₂ transmits the part P₁₂ to the client C₁₄.

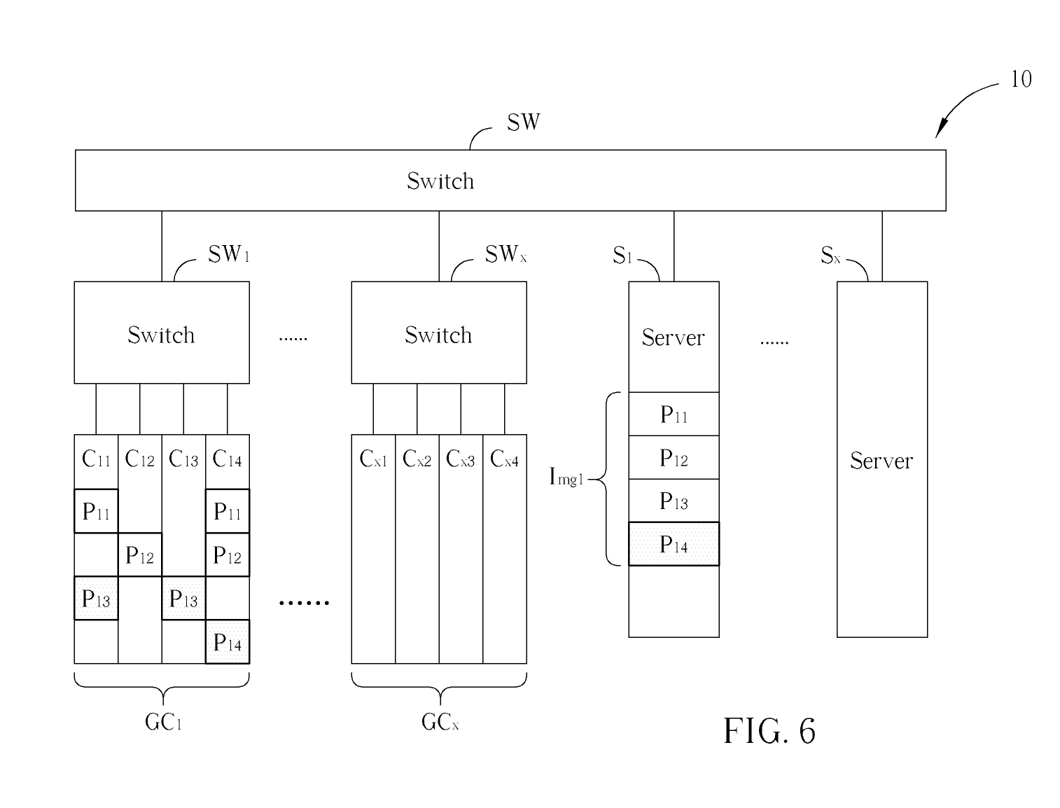

as shown in FIG. 6, the server S₁ transmits the part P₁₄ to the client C₁₄, and the client C₁₃ transmits the part P₁₃ to the client C₁₁.

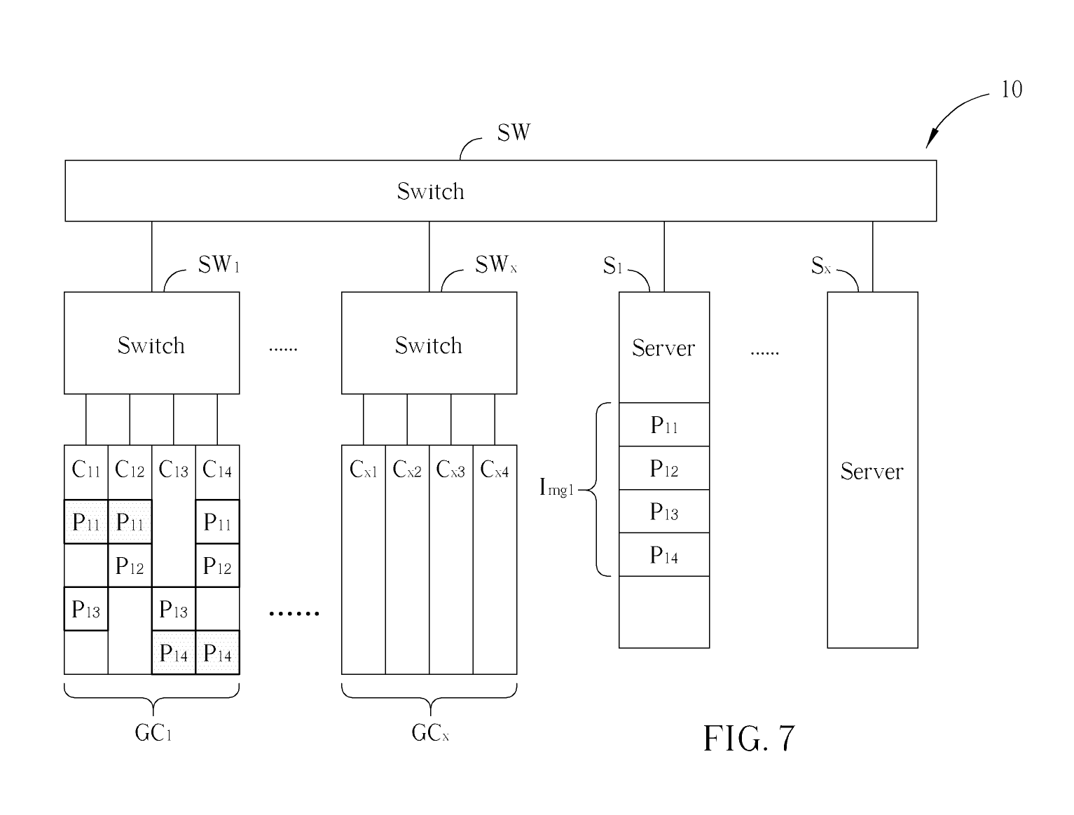

as shown in FIG. 7, the client C₁₁ transmits the part P₁₁ to the client C₁₂, and the client C₁₄ transmits the part P₁₄ to the client C₁₃.

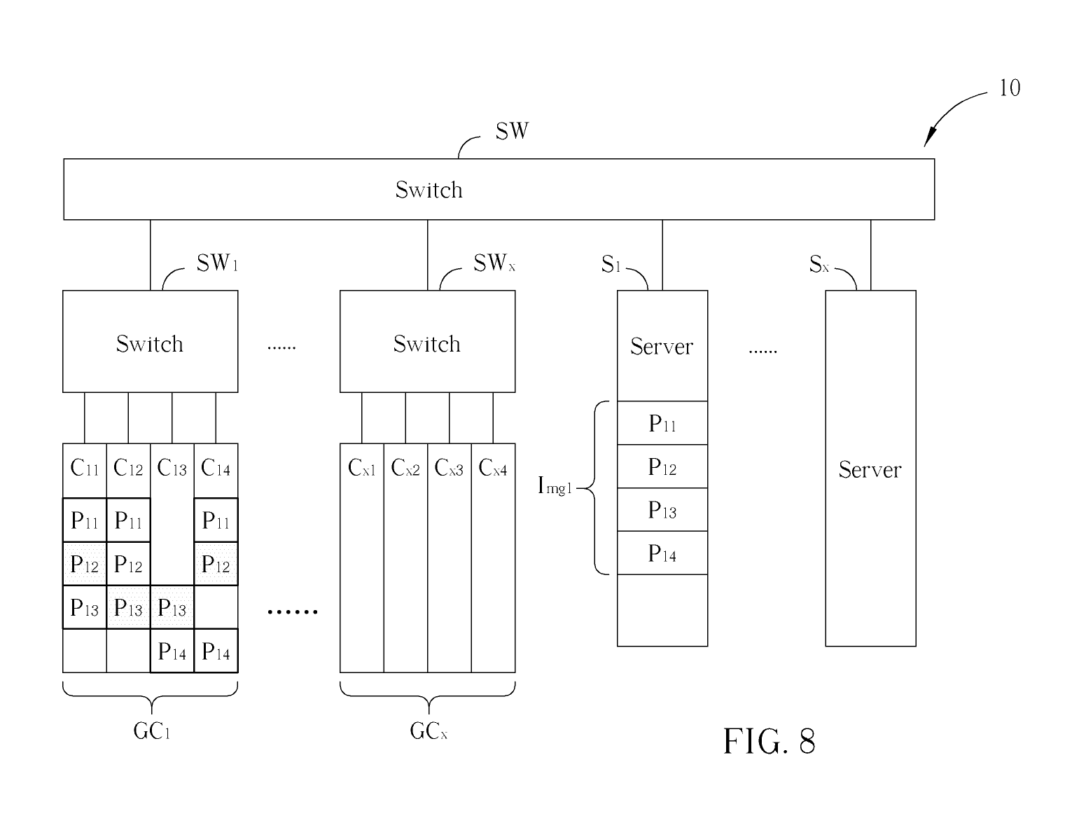

as shown in FIG. 8, the client C₁₄ transmits the part P₁₂ to the client C₁₁, and the client C₁₃ transmits the part P₁₃ to the client C₁₂.

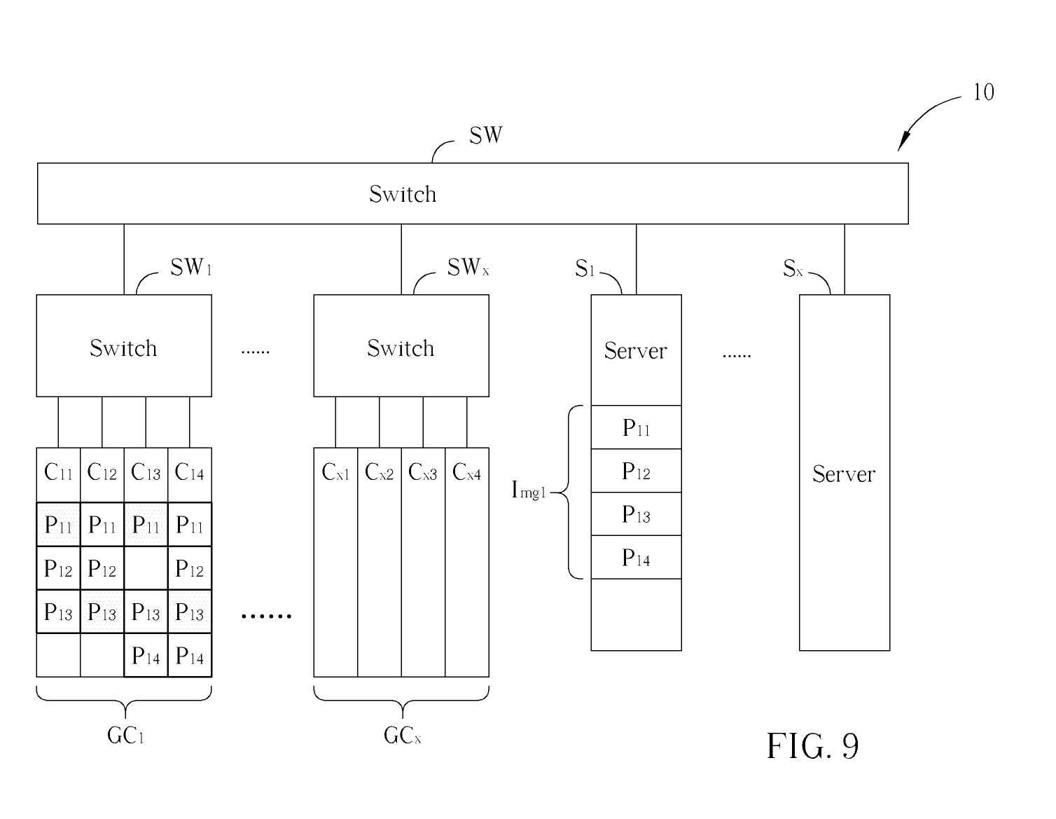

as shown in FIG. 9, the client C₁₁ transmits the part P₁₁ to the client C₁₃, and the client C₁₂ transmits the part P₁₃ to the client C₁₄.

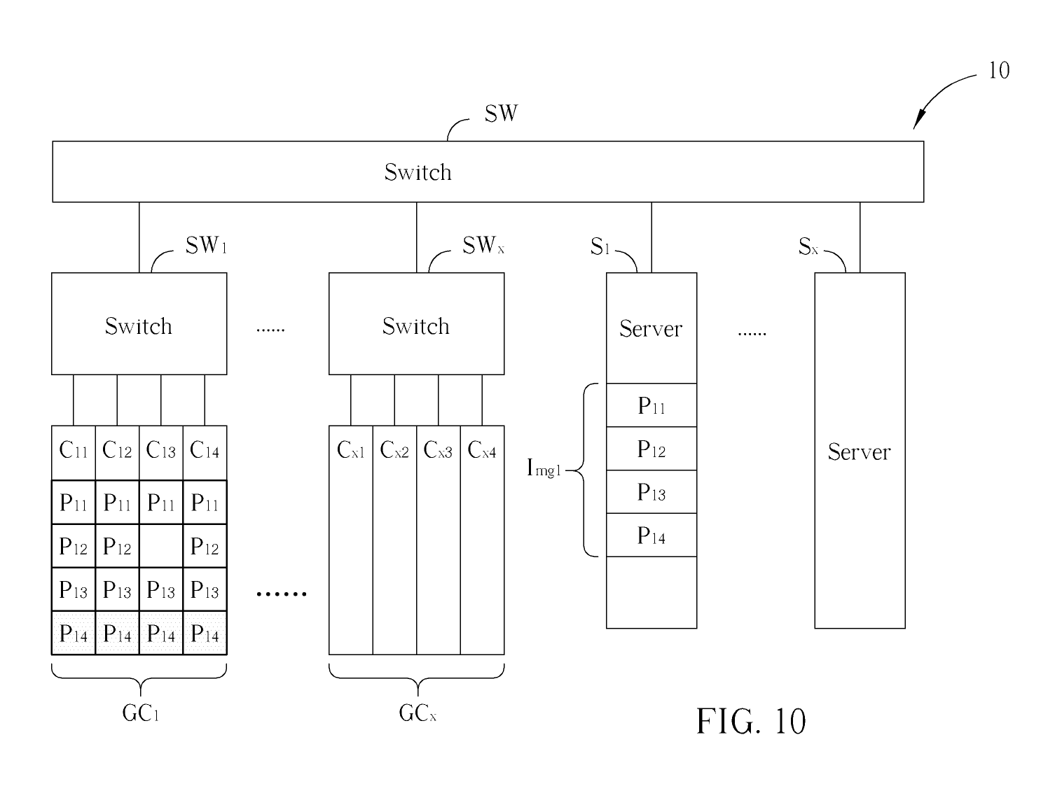

as shown in FIG. 10, the client C₁₃ transmits the part P₁₄ to the client C₁₁, and the client C₁₄ transmits the part P₁₄ to the client C₁₂.

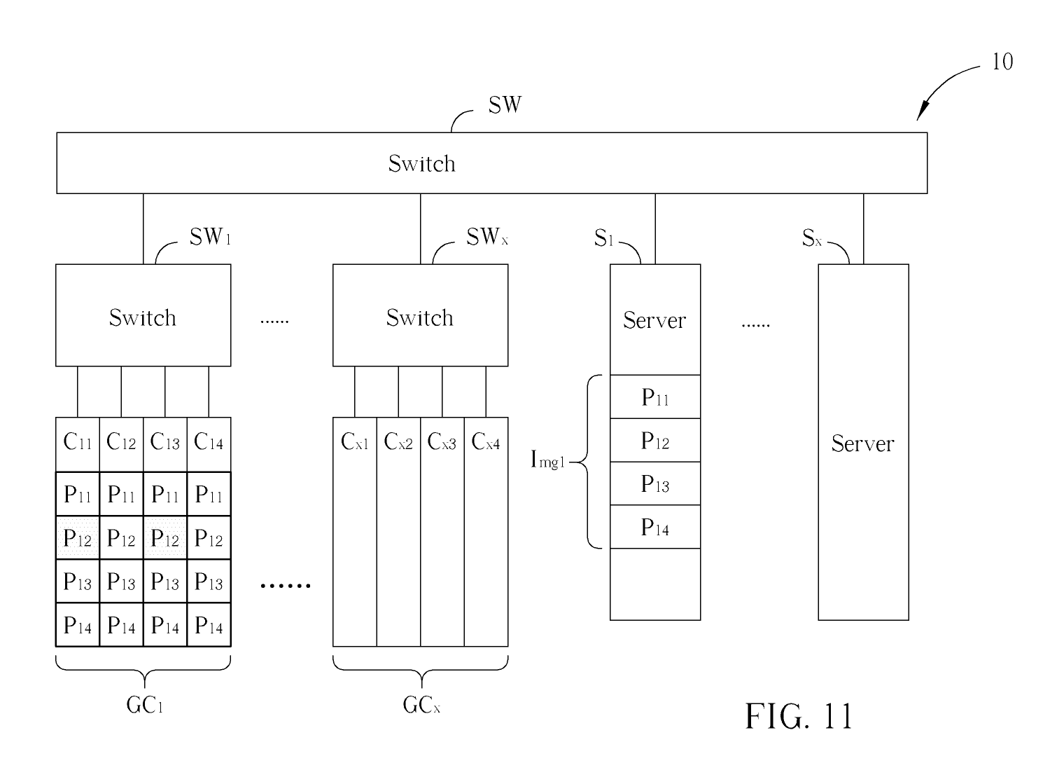

as shown in FIG. 11, the client C₁₁ transmits the part P₁₂ to the client C₁₂.

Since the file Img₁ is divided into 4 parts P₁₁-P₁₄, transmission time for each part is reduced to a quarter (e.g. 1 minute) of an original transmission time for the file Img₁. As shown in FIGS. 3 to 11, to completely deploy the parts P₁₁-P₁₄ of the file Img₁ to the clients C₁₁-C₁₄, it requires a total time of transmitting 9 parts (e.g. 9 minutes). Therefore, for a same image file, the time required for P2P deployment according to an embodiment of the invention is 2.25 times of that for the conventional multicast method (e.g. 4 minutes).

However, the other servers S₂-Sₓ and the other client groups GC₂-GCₓ may also concurrently deploy the files Img₂-Imgₓ to all the clients of the client groups GC₂-GCₓ according to the above-mentioned operations shown in FIGS. 3 to 11, while the server S₁ is deploying the file Img₁ to all the clients C₁₁-C₁₄ of the client groups GC₁. In other words, the invention is able to increase servers so as to concurrently deploy other image files. Therefore, when there is an increase in the quantity of image files that need to be deployed, the deployment time can be maintained to be the same as that for deploying a single system image file. For example, for the conventional multicast method to deploy 8 different image files, it requires 8 times the original required time to deploy a single image file (e.g. 32 minutes), whereas the deployment time for deploying 8 image files via P2P according to the invention remains 2.25 times (e.g. 9 minutes) of that for the conventional multicast method to deploy a single image file, vastly increasing production efficiency.

Note that, the essence of the invention is that different servers may concurrently transmit files to different client groups via P2P, without sharing a fixed bandwidth. Therefore, it is possible to arbitrarily increase the quantity of servers to speed up the deployment of an increased quantity of different system image files to the client groups. Those skilled in the art should make modifications or alterations accordingly. For example, an order in which the server S₁ and the client group GC₁ perform P2P transmission is not limited to the sequence shown in FIGS. 3 to 11, providing that suitable arrangements are made to ensure the parts P₁₁-P₁₄ are concurrently transmitted via P2P, without affecting each other's bandwidths. For example, in the above-mentioned embodiment shown in FIGS. 3 to 11, the server S₁ stops transmission after transmitting all parts P₁₁-P₁₄ of the file Img₁ (since the client group GC₁ includes an even quantity of clients C₁₁-C₁₄, continued transmission by the server S₁ is effectively the same as the clients C₁₁-C₁₄ transmitting among each other). In fact, it is possible to have the server S₁ continue transmitting (e.g. if the client group GC₁ includes an odd quantity clients, the server S₁ may continue transmitting to create an extra transmission path).

Moreover, in the above-mentioned embodiment the quantity of the parts Pₐ₁-Pₐ₄ equals that of the clients Cₐ₁-Cₐ₄ as an example, but this is not limited thereto. The quantity of the parts Pₐ₁-Pₐ₄ is preferred to be greater or equal to that of clients Cₐ₁-Cₐ₄ in a corresponding client groups GCₐ. As such, when the server Sₐ is sequentially and evenly distributing the parts between the clients Cₐ₁-Cₐ₄ in the P2P manner, it is possible for the clients Cₐ₁-Cₐ₄ to commence transmitting received parts to each other via P2P, before the server Sₐ completes transmitting all parts of the file Imgₐ to the clients Cₐ₁-Cₐ₄. For example, the server Sₐ first transmits the part Pₐ₁ to the client Cₐ₁, and while the server Sₐ is transmitting the part Pₐ₂ to the client Cₐ₂, the client Cₐ₁ may transmit the part Pₐ₁ to the clients Cₐ₃ or Cₐ₄. Ideally, the more the quantity of the at least one part into which the file Imgₐ is divided, the earlier the clients Cₐ₁-Cₐ₄ may commence transmitting the received parts with each other in the P2P manner. However, extra overhead on system resources is incurred when dividing the file into at least one part, resulting in a limit to performance improvements (an optimal deployment time is about twice that for the conventional multicast method to deploy a single image file).

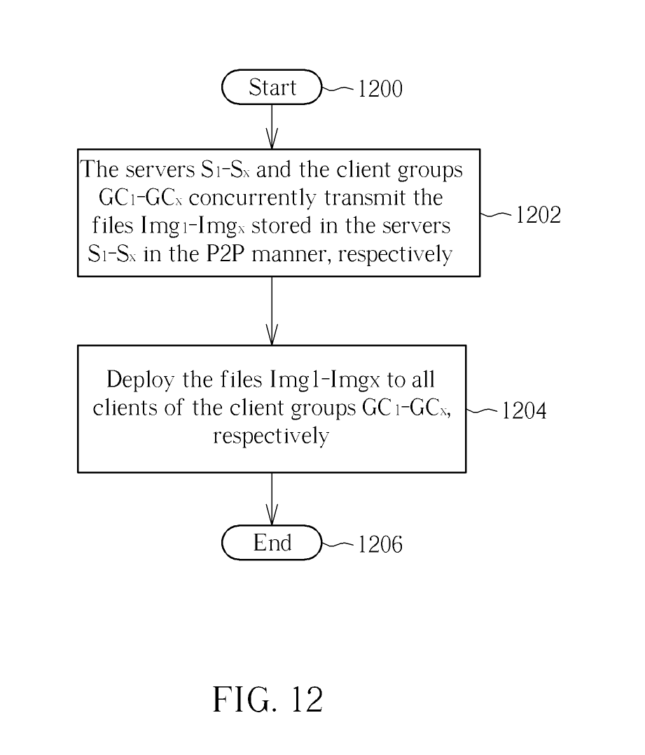

Operations of the above-mentioned communication system 10 may be summarized into a P2P transmission process 120, as shown in FIG. 12, including the following steps:

Step 1200: Start.

Step 1202: The servers S₁-Sₓ and the client groups GC₁-GCₓ concurrently transmit the files Img₁-Imgₓ stored in the servers S₁-Sₓ in the P2P manner, respectively.

Step 1204: Deploy the files Img₁-Imgₓ to all clients of the client groups GC₁-GCₓ, respectively.

Step 1206: End.

In the prior art, when there is an increase in the quantity of system image files to be deployed, the deployment time for the image files increases also. Comparatively, in the invention, different servers are capable of concurrently transmitting files to different client groups in the P2P manner without having to share a fixed bandwidth. Therefore, transmitting multiple system image files from multiple servers to multiple client groups takes the same amount of time as transmitting a single system image file from a single server to a single client group. It is possible to speedup deployment by increasing the quantity of servers when there is an increase in the quantity of different system image files that need to be deployed.

In summary, the invention deploys system image files in a P2P manner, and thus is capable of increasing the quantity of servers accordingly when there is an increase in the quantity of different system image files to be deployed, thereby speeding up the deployment of the system image files in the client groups.

Those skilled in the art will readily observe that numerous modifications and alterations of the device and method may be made while retaining the teachings of the invention.

What is claimed is:

1. A communication system, capable of performing P2P (Peer-to-Peer) transmission, comprising:
a plurality of client groups;
a plurality of first switches, coupled to the plurality of client groups, respectively;
a second switch; and
a plurality of servers, coupled to the plurality of first switches via the second switch, for storing a plurality of files;
wherein a first server of the plurality of servers and a first client group of the plurality of client groups transmit a first file stored in the first server in a P2P manner, to deploy the first file in all clients of the first client group.

2. The communication system of claim 1, wherein a second server of the plurality of servers and a second client group of the plurality of client groups transmit a second file stored in the second server in the P2P manner, to deploy the second file in all clients of the second client group.

3. The communication system of claim 1, wherein the first file is divided into at least one part to be transmitted in the P2P manner.

4. The communication system of claim 3, wherein a quantity of the at least one part is greater than or equal to a quantity of all clients of the first client group.

5. The communication system of claim 3, wherein the first server transmits a first part of the at least one part to a first client of the first client group in the P2P manner.

6. The communication system of claim 5, wherein the first client transmits the first part to a second client of the first client group in the P2P manner.

7. The communication system of claim 6, wherein the second client transmits the first part to a third client of the first client group in the P2P manner, and the third client is different from the first client.

8. The communication system of claim 3, wherein the first server sequentially and evenly distributes the at least one part to each client of the first client group in the P2P manner.

9. The communication system of claim 1, wherein each of the plurality of servers stores one file of the plurality of files, respectively.

10. The communication system of claim 1, wherein the plurality of files are a plurality of different system image files.

11. A P2P (Peer-to-Peer) transmission method for a communication system, the communication system comprising a plurality of client groups coupled to a plurality of first switches, respectively, and a plurality of servers coupled to the plurality of first switches via a second switch, for storing a plurality of files, the P2P transmission method comprising:
a first server of the plurality of servers and a first client group of the plurality of client groups transmitting a first file stored in the first server in a P2P manner; and
deploying the first file in all clients of the first client group.

12. The P2P transmission method of claim 11, further comprising:
a second server of the plurality of servers and a second client group of the plurality of client groups transmitting a second file stored in the second server in the P2P manner; and
deploying the second file in all clients of the second client group.

13. The P2P transmission method of claim 11, wherein the step of the first server of the plurality of servers and the first client group of the plurality of client groups transmitting the first file stored in the first server in the P2P manner comprises:
dividing the first file into at least one part to perform P2P transmission.

14. The P2P transmission method of claim 13, wherein a quantity of the at least one part is greater than or equal to a quantity of all clients of the first client group.

15. The P2P transmission method of claim 13, wherein the step of the first server of the plurality of servers and the first client group of the plurality of client groups transmitting the first file stored in the first server in the P2P manner comprises:
the first server transmitting a first part of the at least one part to a first client of the first client group in the P2P manner.

16. The P2P transmission method of claim 15, wherein the step of the first server of the plurality of servers and the first client group of the plurality of client groups transmitting the first file stored in the first server in the P2P manner comprises:
the first client transmitting the first part to a second client of the first client group in the P2P manner.

17. The P2P transmission method of claim 16, wherein the step of the first server of the plurality of servers and the first client group of the plurality of client groups transmitting the first file stored in the first server in the P2P manner comprises:
the second client transmitting the first part to a third client of the first client group in the P2P manner, wherein the third client is different from the first client.

18. The P2P transmission method of claim 13, wherein the step of the first server of the plurality of servers and the first client group of the plurality of client groups transmitting the first file stored in the first server in the P2P manner comprises:
the first server sequentially and evenly distributing the at least one part to each client of the first client group in the P2P manner.

19. The P2P transmission method of claim 11, wherein each of the plurality of servers stores one file of the plurality of files, respectively.

20. The P2P transmission method of claim 11, wherein the plurality of files are a plurality of different system image files.
